(19) United States
(12) Patent Application Publication
(10) Pub. No.: US 2010/0024432 A1
(43) Pub. Date: Feb. 4, 2010

(54) Method for improved efficiency for IGCC

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 12/459,881

(22) Filed: Jul. 9, 2009

Related U.S. Application Data
(60) Provisional application No. 61/137,642, filed on Aug. 1, 2008.

(51) Int. Cl. F02C 3/28; F01K 7/16; F01K 11/00; F01K 23/10

(52) U.S. Cl. 60/780; 60/39.12; 60/39.5; 60/670

(57) ABSTRACT

A system and a method for improving the thermal efficiency for power production from coal is provided. The system utilizes a gasifier reactor for the conversion of coal to a hot high-pressure fuel gas wherein the fuel gas contains carbon monoxide and hydrogen. The system includes a flow chamber to mix the fuel gas with an oxygen-containing gas to produce a combusted fuel rich product gas that is then passed to a turbine engine connected to the flow chamber. The turbine engine defines a turbine exhaust duct to feed exhaust gas to a reheat combustor and a heat recovery boiler connected to the reheat combustor provides steam to a steam turbine system.

### CROSS-REFERENCE

This application claims the benefit of U.S. Provisional Application No. 61/137,642 filed Aug. 1, 2008.

### FIELD OF THE INVENTION

The present invention relates to a method and an apparatus for improving the thermal efficiency of integrated coal gasification combined cycle (IGCC) gas turbine systems. In particular, the present invention comprises a method for maximizing system efficiency and enabling low cost recovery of carbon dioxide.

### BACKGROUND OF THE INVENTION

### Brief Description of the Related Art

With energy usage directly related to economic growth, there has been a steady increase in the need for increased energy supplies. In the U.S., coal is abundant and low in cost. Unfortunately, conventional coal-fired steam plants, which are a major source of electrical power, are inefficient and pollute the air. Thus, there is a pressing need for cleaner, more efficient coal-fired power plants.

In response, systems have been developed which can achieve significantly improved efficiencies in comparison to conventional steam plants. In such a system, syngas (a mixture of hydrogen and carbon monoxide) is produced by partial oxidation of coal or other carbonaceous fuel in the presence of steam. This allows capture of mercury and sulfur as well as other impurities before combustion. Note that mercury is readily removed, typically with an adsorber bed. Although this avoids the stack gas mercury emissions of a conventional steam plant, the spent adsorber represents a hazard waste for disposal.

If carbon sequestration is desired, the carbon monoxide can be reacted with steam using the water-gas-shift reaction to form carbon dioxide and hydrogen. Note, however, that that the net heating value of the produced hydrogen (275 BTU per cu ft) represents a fifteen percent loss compared to the 322 BTU per cu ft net heating value of the carbon monoxide used. Carbon dioxide may then be recovered using conventional technologies known in the art This allows pre-combustion recovery of carbon dioxide for sequestration.

Regardless of whether carbon dioxide is recovered or whether air or oxygen are used for syngas production, much of the hydrogen content of the gas is typically derived from water fed to the system such that a significant portion of the coal carbon is converted to carbon dioxide and hydrogen. The result is a syngas having a reduced net or Lower Heating value (LH) as compared to the original coal.

Despite the problems noted above, IGCC systems are more efficient than conventional steam plants but capital costs are high. However, there remains a need for a system which utilizes more of the coal heating value, reduces capital costs, and also allows sequestering of carbon dioxide and mercury.

### DESCRIPTION OF THE INVENTION

The present invention comprises a method of converting syngas from a coal gasifier to electricity utilizing a combined cycle expansion turbine system. One embodiment of the present invention comprises a system for the production of electrical power. The system utilizes a gasifier reactor for the conversion of coal to a hot high-pressure fuel gas wherein the fuel gas contains carbon monoxide and hydrogen. The system includes a flow chamber to mix the fuel gas with an oxygen-containing gas to produce a combusted fuel rich product gas that is then passed to a turbine engine connected to the flow chamber. The turbine engine defines a turbine exhaust duct to feed exhaust gas to a reheat combustor and a heat recovery boiler connected to the reheat combustor provides steam to a steam turbine system. The steam turbine system may comprise any conventional combined cycle steam plant or a supercritical plant. In another embodiment of the invention, the system may also comprise condenser to remove water from the heat recovery boiler exit gas.

In the system of the present invention, filtered gas is fed directly to an expansion engine. In a preferred embodiment, the filtered gas also comprises the addition of oxidant and diluent to produce a high temperature combustion product containing enough residual fuel values such that after expansion in the turbine, sufficient heat is available to maximize power in a combined cycle steam system. The combusted gas product temperature is limited to the maximum allowable for the turbine at the reducing conditions used.

The present invention avoids the need for heat exchange before the turbine, thereby reducing capital costs and heat exchange losses. The reducing gas fed to the turbine allows a wider selection of turbine metals for higher temperature operation of the turbine. With efficient gas filtration, the feed gas may contain less particulates than encountered with gas turbines in operation with typical residual oils. NOx production is not an issue with fuel rich combustion. Such stoichiometry removes the temperature limit for low NOx combustion, even with air as the oxygen source.

Any gasifier system may be employed in the present invention. A CO₂ fed gasifier preserves coal heating values and the latent heat losses inherent in steam fed gasifiers are avoided. Although coals contain some hydrogen, conversion of coal carbon to hydrogen is undesirable. Coal is reacted with CO₂ to produce a fuel gas containing carbon monoxide.

The carbon monoxide comprises a combination from combustion of the carbon of the feed coal plus additional carbon monoxide from the reduction of carbon dioxide. Fuel efficiencies ten percent higher than conventional IGCC designs are possible. Losses to latent heat of water that are encountered in conventional systems may be avoided with the present invention. Although air may be used as the oxygen source, combustion of the product gas with pure oxygen produces a combustion product stream from which carbon dioxide may be readily recovered.

In a method of the present invention, coal, oxygen, and carbon dioxide are passed to a gasifier operating at a high temperature, typically well over 1000° Celsius. A catalyst such as potassium carbonate may be used. To capture impurities in the ash, operating temperature must be sufficiently above the ash melting point so that molten ash may be quenched in a water pool as in conventional gasifiers. This process forms a glassy frit, commonly referred to as slag, and such media encapsulates ash toxics. Additionally, mercury may be sequestered underground rather than collected on an adsorbent creating a hazardous waste for disposal. Sulfur can be recovered from the exhaust. Conventional mercury and sulfur recovery systems may be used. CO₂ capture for sequestration is inherent with combustion using oxygen, requiring only condensation of water.

With carbon dioxide fed to the gasifier in place of steam, product gas represents a high fuel value fuel containing nearly all the lower heating value energy of the original coal. As fuel to a turbine, overall thermal efficiency from coal is at least about five percent higher than conventional coal gasifier systems.

### BRIEF DESCRIPTION OF THE DRAWINGS

FIG. 1 depicts a block diagram of an oxygen-blown IGGC system according to the present invention.

FIG. 2 depicts a block diagram of an oxygen-blown IGGC system according to the present invention with mercury and sulfur recovery prior to turbine exhaust reheating.

FIG. 3 depicts a block diagram of an oxygen-blown IGGC system according to the present invention in which air is used in stead of high purity oxygen for combusting gasifier fuel gas.

FIG. 4 depicts a block diagram of an oxygen-blown IGGC system according to the present invention in which a second turbine expansion unit is powered by a reheated exhaust fuel gas and air mixture.

### DETAILED DESCRIPTION OF THE INVENTION

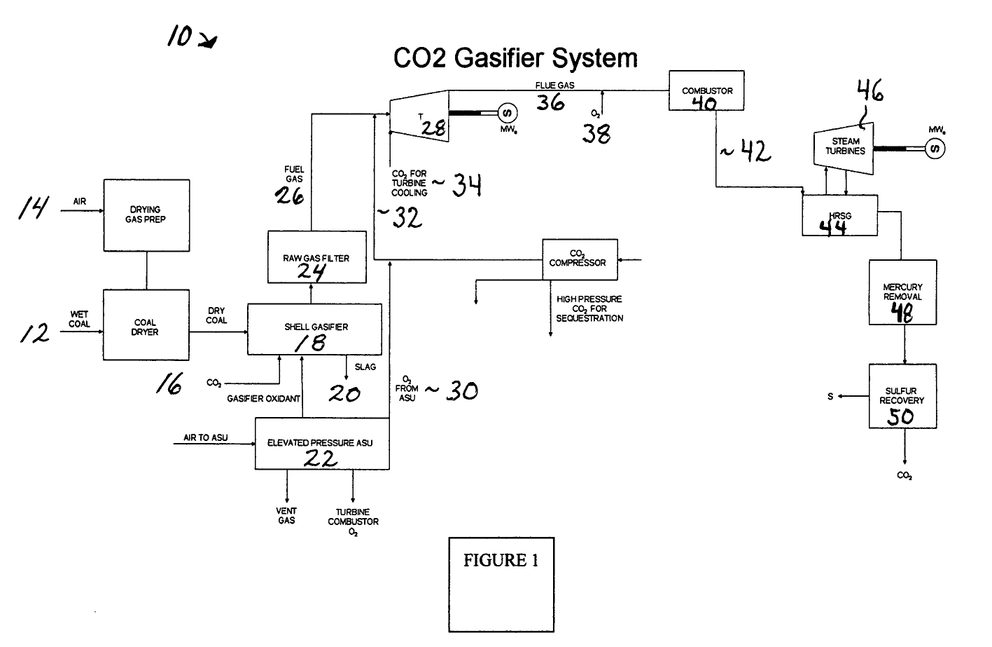

FIG. 1 depicts a simplified schematic diagram of an oxygen-blown IGGC system 10 according to the present invention. As shown, coal 12, oxygen 14 and carbon dioxide 16 are fed to a gasifier reactor 18. The coal may have first been passed through a drying process. Numerous gasifier designs have been developed including entrained flow, fluidized bed systems and countercurrent flow designs. Ash or slag 20 is removed for disposal as water quenched slag as in conventional gasifier systems.

The oxygen may be in the form of air, or, preferably, it is supplied by an air separation plant 22 which may comprise a membrane separator or more typically an air liquefaction plant. The gasifier product preferably is passed to a gas filter 24 to remove particulates in the gas exiting the gasifier and then the filtered hot product gas, or turbine fuel gas 26, is passed to the turbine engine 28. The hot product gas, or filtered fuel, is mixed with oxygen 30, preferably obtained from the air liquefaction plant 22 via a flow duct, and diluent gas 32 forming a fuel rich mixture for entrained flow combustion and for delivery to the turbine. In one embodiment of the invention, the diluent 32 may be obtained from a CO₂ compressor via a flow duct. With liquid CO₂, a pump rather than a compressor may be used to supply CO₂ at high pressure. In another embodiment of the invention, CO₂ 34 may be provided for turbine cooling via a flow duct.

Turbine exhaust fuel gas 36 is mixed with oxygen 38 for combustion of fuel values within reheat combustor 40. Again, the oxygen is preferably obtained from the air liquefaction plant 22. Following addition of oxygen 38 to the exhaust fuel gas 36 and subsequent combustion, the reheated gas stream 42 is fed to a heat recovery steam generator 44 to supply the steam for the combine cycle steam turbines 46. Mercury and sulfur may be recovered from the heat recovery boiler vent gas via conventional mercury removal means 48 and sulfur recovery means 50, or sequestered along with the carbon dioxide effluent. This eliminates significant energy losses. Carbon dioxide sequestration disposes of mercury and sulfur along with carbon dioxide. The mercury hazardous waste issue is eliminated. Moreover, with oxygen as the oxidant, carbon dioxide is recovered by condensation of water.

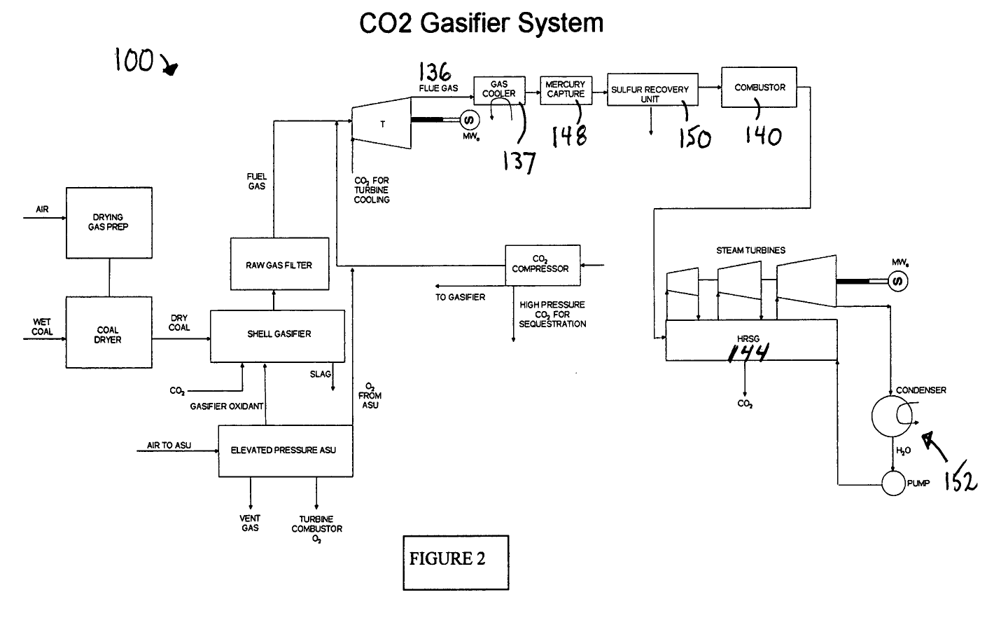

FIG. 2 depicts a simplified schematic diagram of an oxygen-blown IGGC system 100 according to the present invention. System 100 incorporates a means 137 for cooling exhaust fuel gas 136 exiting the turbine exhaust duct and positions mercury capture means 148 and sulfur recovery means 150 downstream of the turbine exhaust duct and prior to reheat combustor 140 and turbine exhaust reheating in heat recovery steam generator 144. In the systems of FIG. 1 and 2, carbon dioxide is recovered for disposal by condensing combustion water via conventional means 152.

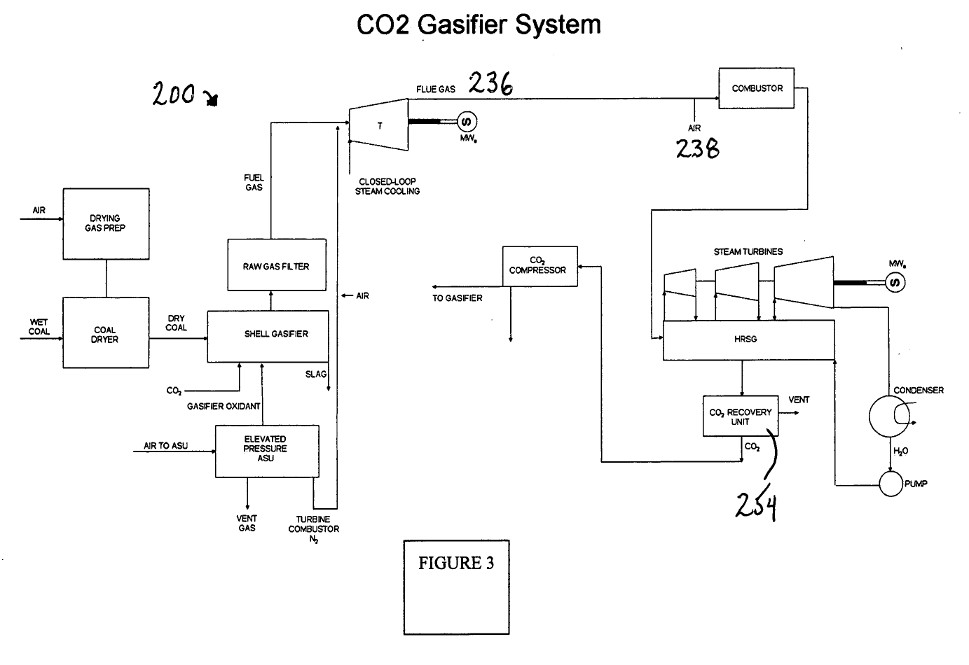

FIG. 3 depicts a simplified schematic diagram of an oxygen-blown IGGC system 200 according to the present invention. In system 200, air 238 is used instead of high purity oxygen for combusting exhaust fuel gas 236. Thus, recovery of carbon dioxide for sequestration or other use requires a separation system 254 such as developed for removal of carbon dioxide from natural gas or other gases.

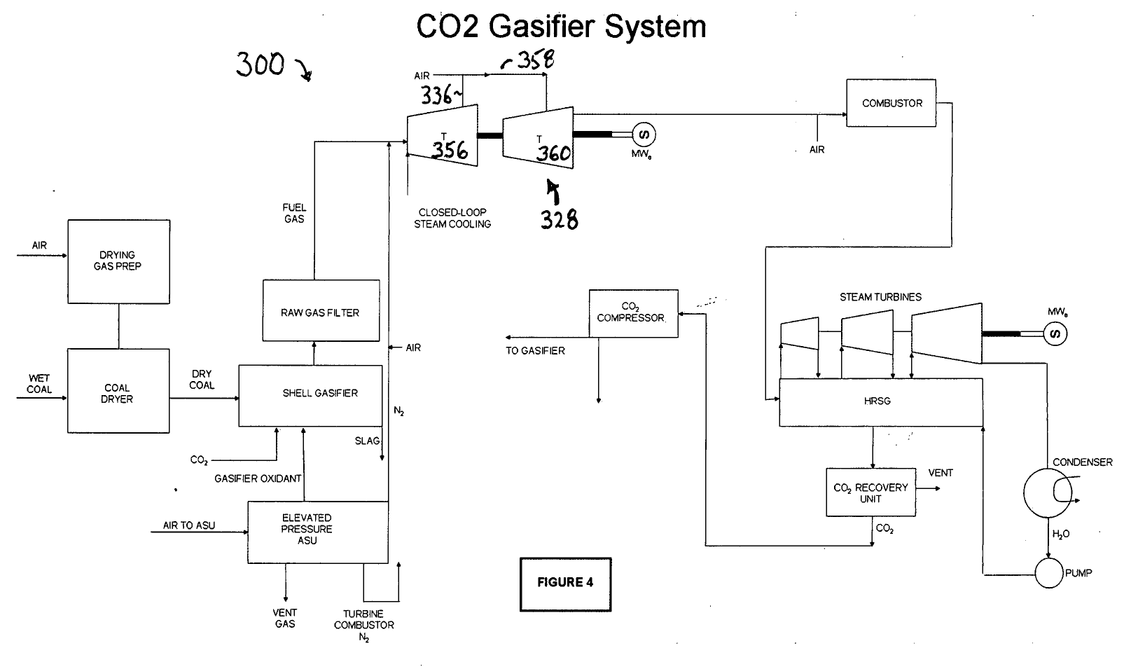

FIG. 4 depicts a simplified schematic diagram of an oxygen-blown IGGC system 300 according to the present invention. In system 300, a partially expanded product gas 336 is passed to a first flow duct from a first expansion unit 356 of turbine engine 328 for mixing the partially expanded product gas with an oxygen containing gas 358. The admixture is reheated by entrained combustion, or combustion in a combustor (not shown). The combustion product gas is passed to a second expansion unit, or second turbine engine, 360 via a second flow duct for fall expansion, producing a turbine exhaust, and thereby providing further system efficiencies and increased power output.

In another embodiment of the present invention, a turbine system may be operated using coal as fuel. A supply of coal and oxygen is passed to a reactor for gasification at an elevated pressure thereby reacting the coal with the oxygen to produce a hot fuel gas containing carbon monoxide. The hot fuel gas is mixed with an oxygen-containing gas to produce a combusted hot fuel-rich product gas and the hot fuel-rich product gas is passed to a turbine to produce power and a cooled gas at a lower pressure. Typically, mixing the hot fuel gas with an oxygen-containing gas to produce a combusted hot fuel-rich product gas comprises entrained flow combustion; however, a reheat combustor also may be used.

An oxygen-containing gas may be mixed with a diluent gas to produce the hot fuel-rich product gas at a temperature suitable for operation of the turbine. The oxygen-containing gas may be obtained from an air separation plant. Preferably, the diluent is carbon dioxide and is admixed with the fuel gas prior to filtration and prior to being fed to the turbine to limit the turbine inlet temperature to a desired temperature for optimum performance.

Preferably, the cooled gas exiting the turbine contains sufficient fuel values to power a steam plant. An oxidant may be added to the cooled gas and the residual fuel values will be combusted in a reheat combustor thereby producing combustion products. The combustion products are passed to a heat recovery boiler to generate steam to power a steam plant for production of electrical power.

Although the invention has been described in considerable detail with respect to improving the thermal efficiency of an IGCC gas turbine system, it will be apparent that the invention is capable of numerous modifications and variations, apparent to those skilled in the art, without departing from the spirit and scope of the invention.

1. A system for production of electrical power comprising:
a) a gasifier reactor for conversion of coal to a hot high pressure fuel gas wherein the fuel gas contains carbon monoxide and hydrogen;
b) a flow chamber to mix the fuel gas with an oxygen-containing gas to produce a combusted fuel rich product gas;
c) a turbine engine connected to the flow chamber;
d) a turbine exhaust duct to feed exhaust gas to a reheat combustor; and
e) a heat recovery boiler connected to the reheat combustor to provide steam to a steam turbine system.

2. The system of claim 1 having an air separation plant to provide high purity oxygen to the gasifier.

3. The system of claim 1 further comprising a first flow duct for passing a partially expanded product gas from the turbine engine and mixing the partially expanded product gas with an oxygen-containing gas prior to passage to a second turbine engine to produce a turbine exhaust.

4. The system of claim 1 wherein the steam turbine system is a supercritical plant.

5. The system of claim 1 wherein the turbine exhaust duct feeds a sulfur recovery system prior to the reheat combustor.

6. The system of claim 1 having a hot gas filter to remove particulates in the gas exiting the gasifier.

7. The system of claim 2 having a flow duct to deliver oxygen from the air separation plant for admixture with the filtered fuel gas prior to passing the fuel gas to the turbine.

8. The system of claim 7 having a flow duct to deliver a diluent gas for admixture with the fuel gas prior to filtration and passage to the turbine.

9. The system of claim 5 wherein a means for mercury recovery is positioned downstream of the turbine exhaust duct and prior to the reheat combustor.

10. The system of claim 5 wherein a means for sulfur recovery is positioned downstream of the turbine exhaust duct and prior to the reheat combustor.

11. The system of claim 1 wherein a means for mercury removal and a means for sulfur removal are positioned to process heat recovery boiler vent gas.

12. The system of claim 2 having a condenser to remove water from the heat recovery boiler exit gas.

13. The system of claim 12 having compressor to compress carbon dioxide for recycle to the gasifier and as diluent for the gasifier product gas.

14. The system of claim 1 having a filter to process combusted fuel rich product gas prior to passing the gas to the turbine.

15. The method of operating a turbine system using coal as fuel comprising:
a) passing a supply of coal and oxygen to a reactor for gasification at an elevated pressure;
b) reacting the coal with the oxygen to produce a hot fuel gas containing carbon monoxide;
c) mixing the hot fuel gas with an oxygen-containing gas to produce a combusted hot fuel-rich product gas; and
d) passing the product gas to a turbine to produce power and a cooled gas at a lower pressure.

16. The method of claim 15 wherein an oxygen-containing gas is mixed with a diluent gas to produce the hot fuel-rich product gas at a temperature suitable for operation of the turbine.

17. The method of claim 15 wherein the cooled gas contains sufficient fuel values to power a steam plant.

18. The method of claim 15 wherein the oxygen-containing gas contains oxygen from an air separation plant.

19. The method of claim 16 wherein the diluent is carbon dioxide fed to the fuel gas prior to the turbine to limit the turbine inlet temperature.

20. The method of claim 16 wherein the diluent is admixed with the fuel gas prior to filtration.

21. The method of claim 15 wherein an oxidant is added to the cooled gas and the residual fuel values are combusted in a reheat combustor thereby producing combustion products.

22. The method of claim 21 wherein the combustion products are passed to a heat recovery boiler to generate steam to power a steam plant for production of electrical power.

23. The method of claim 15 wherein the step of mixing the hot fuel gas with an oxygen-containing gas to produce a combusted hot fuel-rich product gas comprises entrained flow combustion.
